(19) United States
(12) Patent Application Publication
(10) Pub. No.: US 2026/0189122 A1
(43) Pub. Date: Jul. 2, 2026

(54) CONTROLLER OF POWER CONVERTER

(71) Applicant: uPI semiconductor corp., Zhubei City (TW)

(72) Inventors: Yin-Kang CHEN, Zhubei City (TW); Dong-Lin WU, Zhubei City (TW); Min-Tzu WANG, Zhubei City (TW)

(21) Appl. No.: 19/386,306

(22) Filed: Nov. 12, 2025

(30) Foreign Application Priority Data
Dec. 30, 2024 (TW) 113151496

(51) Int. Cl. H02M 1/00; H02M 1/088; H02M 3/158

(52) U.S. Cl. CPC H02M 1/0025; H02M 1/0038; H02M 1/088; H02M 3/158

(57) ABSTRACT

A controller of a power converter is disclosed. The controller includes an error amplifier, a compensation circuit, a comparison circuit, an adjustment circuit and a control signal generation circuit. The error amplifier is coupled to the power converter and generates an error signal according to an output voltage. The compensation circuit is coupled to the error amplifier and generates a compensation signal according to the error signal. The compensation circuit includes a compensation resistor. The comparison circuit is coupled to the compensation circuit and generates a trigger signal according to the compensation signal. The adjustment circuit generates an adjustment signal according to a cross-voltage between two terminals of the compensation resistor. The control signal generation circuit is coupled to the comparison circuit and the adjustment circuit and generates a control signal according to the trigger signal and the adjustment signal.

### BACKGROUND OF THE INVENTION

### 1. Field of the invention

The invention relates to a power converter; in particular, to a controller of a power converter.

### 2. Description of the prior art

The pulse-width modulation (PWM) signal used by the conventional constant on-time (COT) power converter is set by comparing the error signal with the ramp signal, and the on-time generator calculates the on-time (TON) based on the input voltage and the output voltage. The above-mentioned on-time will fluctuate because the input voltage provided by the power supply is not stable. Therefore, a loop compensation circuit consisting of a series RC network is typically disposed between the error amplifier and the general compensator to reduce this on-time fluctuation. However, when the input voltage and output voltage of the power converter are close, the conventional loop compensation circuit fails to provide sufficient stability to the loop, causing system instability that needs to be overcome.

### SUMMARY OF THE INVENTION

Therefore, the invention provides a controller of a power converter capable of providing additional function of extending or shortening the on-time to solve the above-mentioned problems of the prior arts.

A preferred embodiment of the invention is a controller of a power converter. In this embodiment, the controller of the power converter used for providing a control signal to cause the power converter to generate an output voltage. The controller includes an error amplifier, a compensation circuit, a comparison circuit, an adjustment circuit and a control signal generation circuit. The error amplifier couples to the power converter and configured to generate an error signal according to the output voltage. The compensation circuit couples to the error amplifier and configured to generate a compensation signal according to the error signal. The compensation circuit includes a compensation resistor. The comparison circuit couples to the compensation circuit and configured to generate a trigger signal according to the compensation signal. The adjustment circuit is configured to generate an adjustment signal according to a cross-voltage between two terminals of the compensation resistor. The control signal generation circuit is coupled to the comparison circuit and the adjustment circuit and configured to generate a control signal according to the trigger signal and adjustment signal.

In an embodiment, the compensation circuit further includes a compensation capacitor, one terminal of the compensation capacitor is coupled to the compensation capacitor and the other terminal of the compensation capacitor is coupled to a ground terminal.

In an embodiment, the adjustment circuit includes a voltage-controlled current source configured to generate a current signal related the input voltage as the adjustment signal according to the cross-voltage between the two terminals of the compensation resistor.

In an embodiment, the control signal generation circuit includes an on-time generation unit and a logic control unit. The on-time generation unit is coupled to the adjustment circuit and configured to generate a first on-time or a second on-time according to the adjustment signal. The logic control unit is coupled to the on-time generation unit and configured to generate the control signal according to the first on-time or the second on-time.

In an embodiment, the on-time generation unit includes a current source, a second capacitor, a switch and a comparator. The current source couples to a node and configured to provide a current related to the input voltage. The second capacitor is coupled between the node and a ground terminal. The switch has two terminals coupled to two terminals of the second capacitor respectively and configured to be turned on or off by a pulse width modulation signal. The comparator has a positive input terminal and a negative input terminal. The positive input terminal receives the output voltage and the negative input terminal is coupled to the node. When the switch is turned off, the second capacitor is charged by a current, the comparator generates the first on-time or the second on-time based on the first charging voltage at the node and the output voltage.

In an embodiment, the comparator determines the first on-time according to a first time length required for the first charging voltage to rise from zero to the output voltage, and determines the second on-time according to a second time length required for the second charging voltage to rise from zero to the output voltage.

In an embodiment, the comparator generates the first on-time or the second on-time according to whether the adjustment signal generated by the adjustment circuit is a first current signal or a second current signal.

In an embodiment, when a second rising slope of the second charging voltage is greater than a first rising slope of the first charging voltage, the second on-time is less than the first on-time.

In an embodiment, when a second rising slope of the second charging voltage is less than a first rising slope of the first charging voltage, the second on-time is greater than the first on-time.

In an embodiment, the current source is composed of a current mirror circuit.

Compared to the prior art, the controller of the power converter of the present invention can adjust the time required for the charging voltage in the on-time generation unit to rise to the output voltage by using an adjustment signal generated based on the cross-voltage between the two terminals of the compensation resistor, thereby further extending or shortening the on-time. Therefore, it can achieve the effect of transient modulation of the on-time, effectively reducing the overshoot and undershoot phenomenon of the output voltage of the conventional power converter, and providing faster and more stable transient response.

The advantage and spirit of the invention may be understood by the following detailed descriptions together with the appended drawings.

### BRIEF DESCRIPTION OF THE APPENDED DRAWINGS

The accompanying drawings of the present invention are described as follows:

FIG. 1 is a schematic diagram of a controller of a power converter in an embodiment of the present invention.

FIG. 2 is a schematic diagram of an adjustment circuit of a controller in an embodiment of the present invention.

FIG. 3 is a schematic diagram of an on-time generation unit of a controller in an embodiment of the present invention.

FIG. 4 is a waveform diagram of charging voltage and on-time.

FIG. 5 is a waveform diagram of the input voltage, output voltage, inductor current, and second switching signal of the present invention and the prior art.

### DETAILED DESCRIPTION OF THE INVENTION

Exemplary embodiments of the invention are referenced in detail now, and examples of the exemplary embodiments are illustrated in the drawings. Further, the same or similar reference numerals of the components/components in the drawings and the detailed description of the invention are used on behalf of the same or similar parts.

A specific embodiment of the present invention is a controller of a power converter. In this embodiment, the power converter has a constant on-time type and the controller used for providing a control signal to cause the power converter to generate an output voltage.

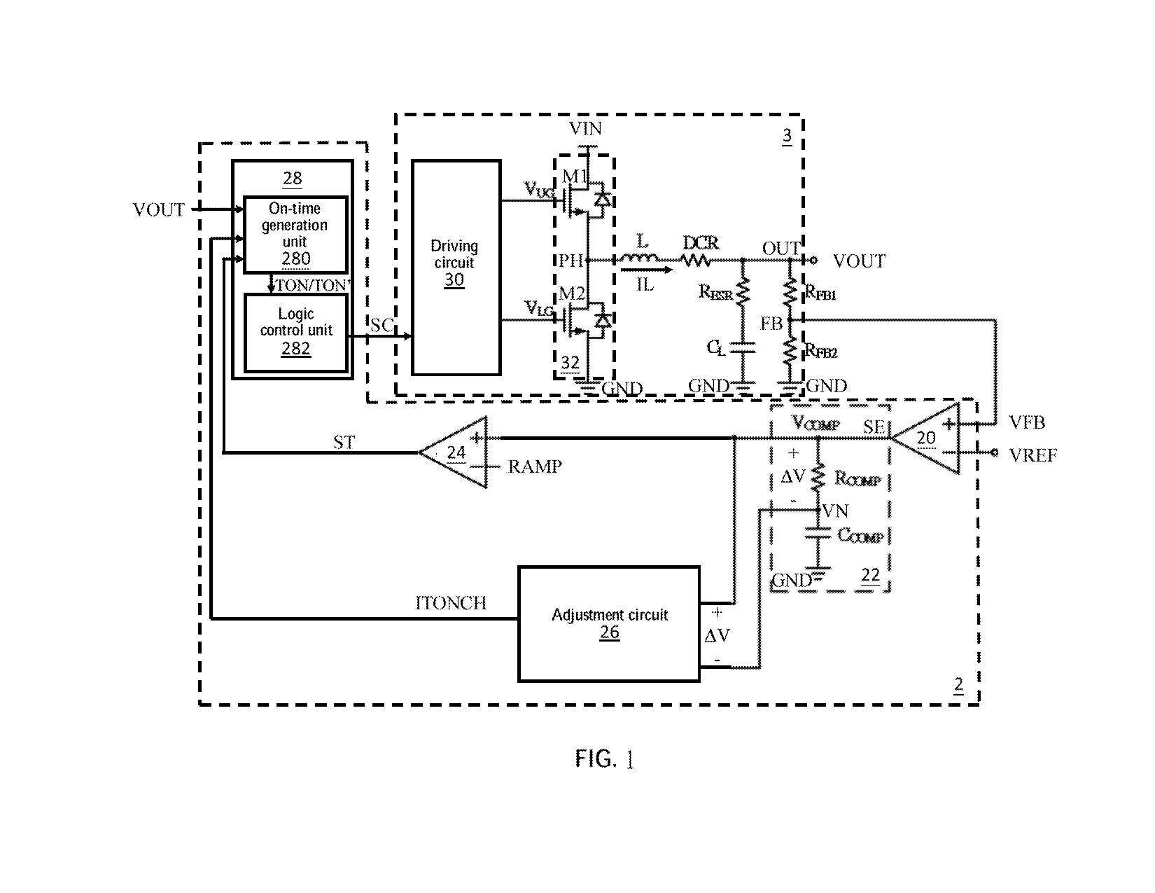

Please refer to FIG. 1. FIG. 1 is a schematic diagram of a controller of a power converter in this embodiment. As shown in FIG. 1, a controller 2 coupled to a power converter 3 and the controller 2 provides a control signal SC to the power converter 3 to cause the power converter 3 to generate an output voltage VOUT.

The controller 2 includes an error amplifier 20, a compensation circuit 22, a comparison circuit 24, an adjustment circuit 26 and a control signal generation circuit 28. A positive input terminal + of the error amplifier 20 coupled to the power converter 3, and an output terminal of the error amplifier 20 coupled to the compensation circuit 22. The compensation circuit 22 is coupled to the output terminal of the error amplifier 20, a positive input terminal + of the comparison circuit 24 and the adjustment circuit 26. The positive input terminal + of the comparison circuit 24 is coupled to the compensation circuit 22, and an output terminal of the comparison circuit 24 is coupled to the control signal generation circuit 28. The adjustment circuit 26 is coupled to the compensation circuit 22 and the control signal generation circuit 28. The control signal generation circuit 28 is coupled to the comparison circuit 24, the adjustment circuit 26 and the power converter 3.

The power converter 3 includes a driving circuit 30, an output stage 32, an inductor L, a resistor DCR, a resistor RESR, a capacitor CL, a first voltage-dividing resistor RFB1, a second voltage-dividing resistor RFB2 and an output terminal OUT. The output stage 32 includes a first switch M1 and a second switch M2 connected in series between an input voltage VIN and a ground voltage GND. An input terminal of the driving circuit 30 coupled to the control signal generation circuit 28, and an output terminal of the driving circuit 30 is coupled to control terminals (gates) of the first switch M1 and the second switch M2 in the output stage 32 respectively. One terminal of the inductor L is coupled to a phase node PH between the first switch M1 and the second switch M2 in the output stage 32, and the other terminal of the inductor L is coupled to the resistor DCR. The phase node PH has a phase voltage and generates an inductor current IL flowing through the inductor L. The resistor DCR is coupled between the inductor L and the output terminal OUT. One terminal of the resistor RESR is coupled between the resistor DCR and the output terminal OUT, and the other terminal of the resistor RESR is coupled to the capacitor CL. The capacitor CL is coupled between the resistor RESR and the ground terminal GND. The output voltage VOUT is outputted from the output terminal OUT. The first voltage-dividing resistor RFB1 and the second voltage-dividing resistor RFB2 are connected in series between the output terminal OUT and the ground terminal GND. A voltage-dividing node FB between the first voltage-dividing resistor RFB1 and the second voltage-dividing resistor RFB2 has a feedback voltage VFB. The feedback voltage VFB is a divided voltage of the output voltage VOUT.

The positive input terminal + of the error amplifier 20 is coupled to the voltage-dividing node FB between the first voltage-dividing resistor RFB1 and the second voltage-dividing resistor RFB2 in the power converter 3 and receives the feedback voltage VFB. The negative input terminal - of the error amplifier 20 receives a reference voltage VREF. The output terminal of the error amplifier 20 outputs an error signal SE to the compensation circuit 22 based on the feedback voltage VFB and the reference voltage VREF. The compensation circuit 22 generates a compensation signal VCOMP based on the error signal SE. The compensation circuit 22 includes a compensation resistor RCOMP and a compensation capacitor CCOMP. One terminal of the compensation resistor RCOMP is coupled between the output terminal of the error amplifier 20 and the positive input terminal + of the comparator circuit 24, and the other terminal of the compensation resistor RCOMP is coupled to the compensation capacitor CCOMP. The voltages of two terminals of the compensation resistor RCOMP are a compensation signal VCOMP and a node voltage VN respectively, and a cross-voltage between the two terminals of the compensation resistor RCOMP is ΔV. The compensation capacitor CCOMP is connected in series between the compensation resistor RCOMP and the ground terminal GND.

The positive input terminal + of the comparison circuit 24 receives the compensation signal VCOMP from the compensation circuit 22, and the negative input terminal - of the comparison circuit 24 receives the ramp signal RAMP. The comparison circuit 24 generates a trigger signal ST based on the compensation signal VCOMP and the ramp signal RAMP, and outputs the trigger signal ST through the output terminal of comparison circuit 24 to the control signal generation circuit 28. The two input terminals of the adjustment circuit 26 are respectively coupled to the two terminals of the compensation resistor RCOMP in the compensation circuit 22 to obtain the cross-voltage ΔV between the two terminals of the compensation resistor RCOMP. The adjustment circuit 26 generates an adjustment signal ITONCH to the control signal generation circuit 28 based on the cross-voltage ΔV between the two terminals of the compensation resistor RCOMP.

The control signal generation circuit 28 receives the trigger signal ST, the adjustment signal ITONCH and the output voltage VOUT, and generates a control signal SC to the driving circuit 30 of the power converter 3 based on the trigger signal ST, the adjustment signal ITONCH and the output voltage VOUT.

In this embodiment, the control signal generation circuit 28 includes an on-time generation unit 280 and a logic control unit 282. The on-time generation unit 280 is coupled to the adjustment circuit 26, the comparison circuit 24, the output terminal OUT and the logic control unit 282. The logic control unit 282 is coupled to the on-time generation unit 280 and the driving circuit 30 of the power converter 3. The on-time generation unit 280 generates a first on-time TON or a second on-time TON’ to the logic control unit 282 based on the output voltage VOUT, different types of adjustment signals ITONCH and the trigger signal ST. The logic control unit 282 generates a corresponding control signal SC to the driving circuit 30 of the power converter 3 based on the first on-time TON or the second on-time TON’.

When the driving circuit 30 receives the control signal SC, the driving circuit 30 generates a first switching signal VUG and a second switching signal VLG to the control terminals (gates) of the first switch M1 and the second switch M2 in the output stage 32 according to the control signal SC. It can control the first switch M1 and the second switch M2 to turn on or turn off. For example, the first switch M1 turn on and the second switch M2 turn off, or the first switch M1 turn off and the second switch M2 turn on.

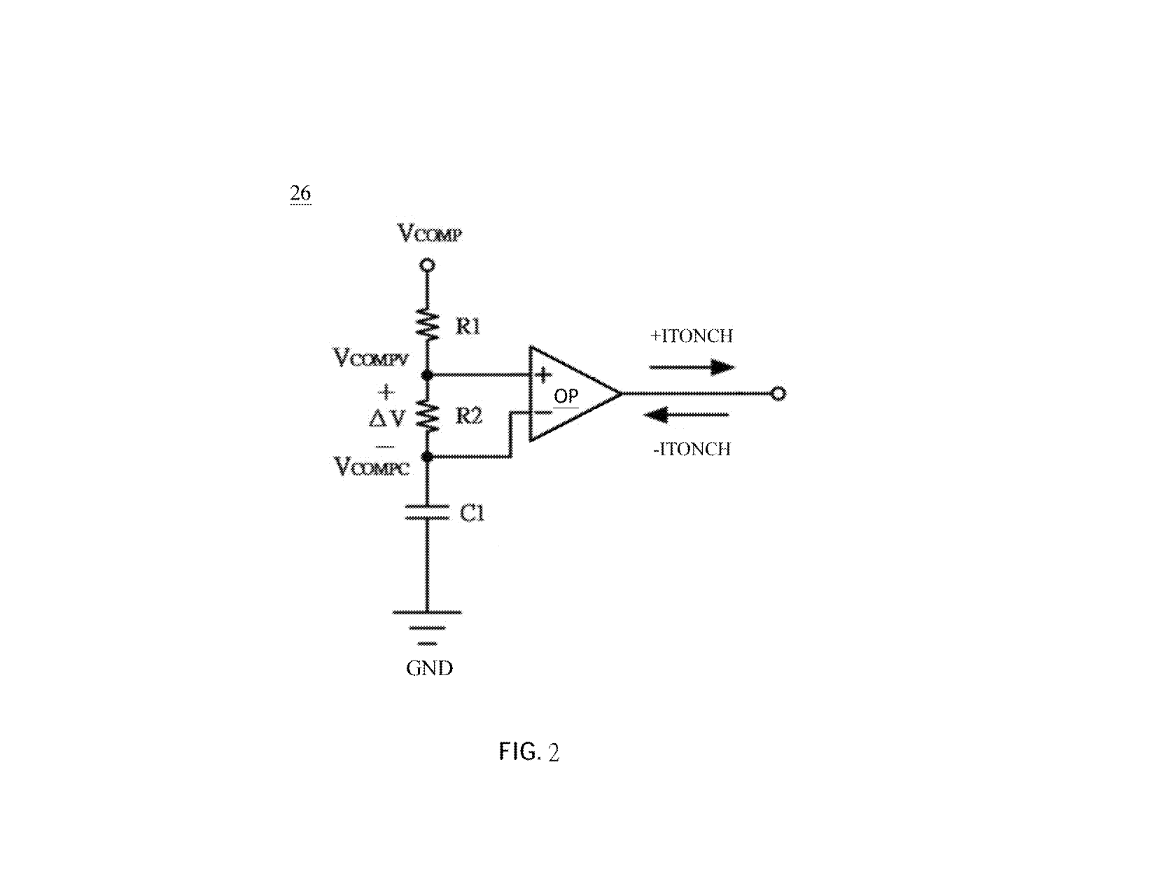

Please refer to FIG. 2. FIG. 2 is a schematic diagram of an embodiment of the adjustment circuit 26 in the controller 2 shown in FIG. 1. As shown in FIG. 2, the adjustment circuit 26 includes an operational amplifier OP, a first resistor R1, a second resistor R2 and a first capacitor C1. All the first resistor R1, the second resistor R2, and the first capacitor C1 are connected in series between the compensation signal VCOMP and the ground terminal GND.

A positive input terminal + of the operational amplifier OP is coupled between the first resistor R1 and the second resistor R2 to receive a first voltage VCOMPV, and a negative input terminal - of the operational amplifier OP is coupled between the second resistor R2 and the first capacitor C1 to receive a second voltage VCOMPC. Hence, the operational amplifier OP receives the cross-voltage ΔV between the two terminals of the second resistor R2. The cross-voltage ΔV between the two terminals of the second resistor R2 is a voltage difference between the first voltage VCOMPV and the second voltage VCOMPC. The operational amplifier OP receives the cross-voltage ΔV and generates a current signal (e.g., a first current signal +ITONCH and a second current signal -ITONCH) related to the input voltage VIN as the adjustment signal ITONCH outputted to the on-time generation unit 280 of the control signal generation circuit 28. In this embodiment, the operational amplifier OP is a voltage-controlled current source.

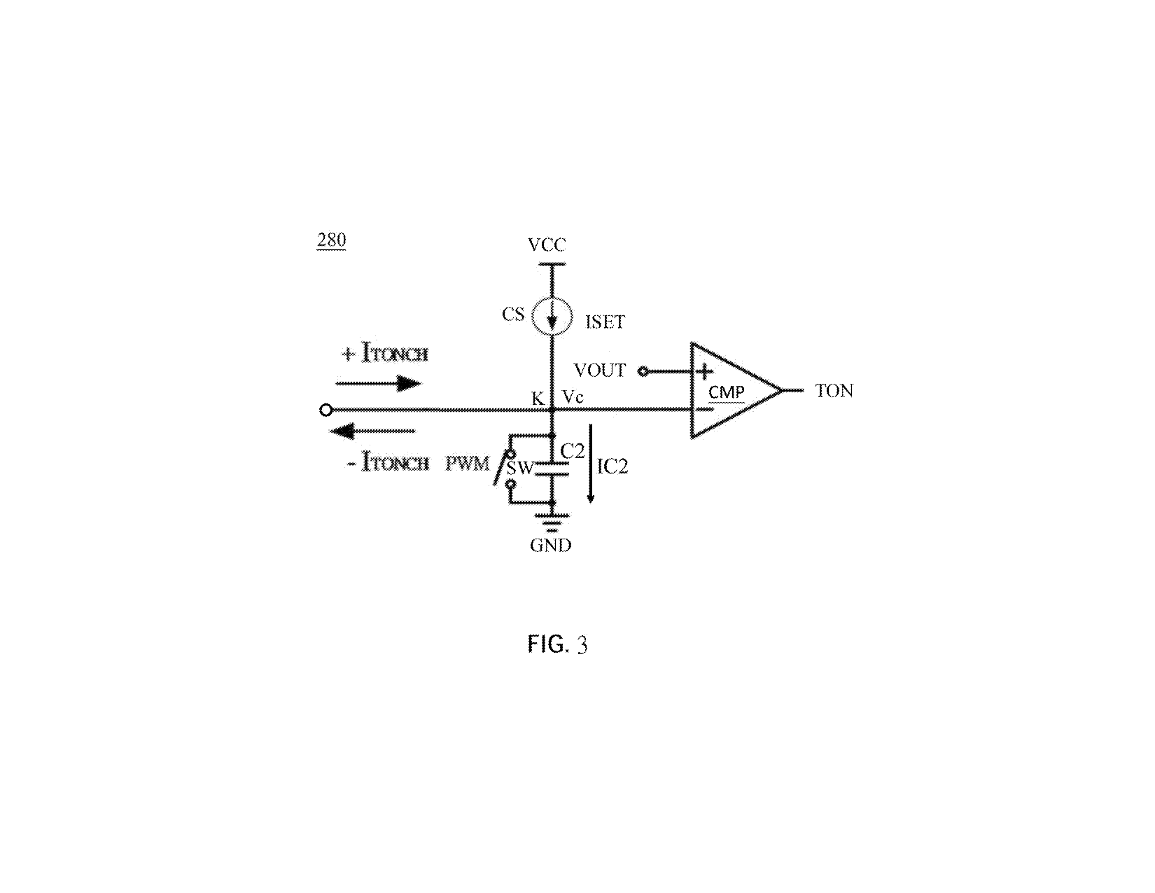

Please refer to FIG3. FIG. 3 is a schematic diagram of an embodiment of the on-time generation unit 280 in the controller 2 shown in FIG. 1. As shown in FIG. 3, the on-time generation unit 280 includes a current source CS, a second capacitor C2, a switch SW and a comparator CMP. The current source CS is coupled between the input voltage VIN and a node K to provide a current ISET related to the input voltage VIN. The second capacitor C2 is coupled between the node K and the ground terminal GND. A positive input terminal + of the comparator CMP receives the output voltage VOUT, and a negative input terminal - of the comparator CMP is coupled to the node K. The adjustment signal ITONCH is the current signal generated by the operational amplifier OP. Two terminals of the switch SW are respectively coupled to two terminals of the second capacitor C2 to be turned on or off by the pulse width modulation signal PWM, thereby controlling the current source CS and the adjustment signal ITONCH to charge or discharge the second capacitor C2. In one embodiment, the current source CS is a current mirror circuit, but not limited to this.

When the switch SW is controlled by the pulse width modulation signal PWM and is turned off (open), the first capacitor C2 is charged by the current ISET provided by the current source CS and the adjustment signal ITONCH, so that the node K has a voltage. The comparator CMP receives the output voltage VOUT and the voltage at the node K respectively, and generates a first on-time TON to the logic control unit 282 accordingly. The current ISET provided by the current source CS is made by the input voltage VIN, and therefore the first on-time is also determined by the input voltage VIN. However, when unloaded, the output voltage VOUT may not be sufficiently stable, or may require longer time to stabilize. Therefore, the adjustment current IC2 depends on the adjustment signal ITONCH, which made by the compensation signal VCOMP. For example, if the on-time generation unit 280 receives the first current signal +ITONCH, the charging current to the second capacitor C2 will increase, thereby increasing the charging speed and shortening the charging time. If the on-time generation unit 280 receives the second current signal -ITONCH, the charging current to the second capacitor C2 will decrease, thereby slowing down the charging speed and increasing the charging time.

It should be noted that the comparator CMP determines the on-time based on the time required for the charging voltage Vc at the node K to rise from zero to the output voltage VOUT. In other words, when a rising slope of the charging voltage Vc at the node K changes, the time required for the charging voltage Vc at the node K to rise from zero to the output voltage VOUT also changes, so that the on-time determined by the comparator CMP also changes. For example, when the rising speed of the charging voltage Vc at the node K slows down, the time required for the charging voltage Vc at the node K to rise from zero to the output voltage VOUT also increases, so that the on-time determined by the comparator CMP also increases; and vice versa.

When the power converter unloaded immediately to cause the output voltage VOUT drops, the compensation signal VCOMP increases. The adjustment circuit 26 generates a second current signal -ITONCH according to the cross-voltage ΔV across the compensation resistor RCOMP, which flows into the on-time generation unit 280 to slow down the charging speed of the second capacitor C2. It prolongs the time required for the second current to rise to the output voltage VOUT, thereby increasing the on-time TON and a duty cycle of the pulse width modulation signal PWM to suppress the undershoot of the output voltage VOUT.

Conversely, when the output voltage VOUT of the power converter rises instantaneously, the adjustment circuit 26 generates a first current signal +ITONCH based on the cross-voltage ΔV across the compensation resistor RCOMP, which flows out of the on-time generation unit 280 to increase the charging speed and shorten the on-time TON. It reduce the duty cycle of the pulse width modulation signal PWM and suppressing the overshoot of the output voltage VOUT. Thus, the present invention can achieve the effect of accelerating the transient response speed and provide a better response than a conventional constant on-time (COT) power converter.

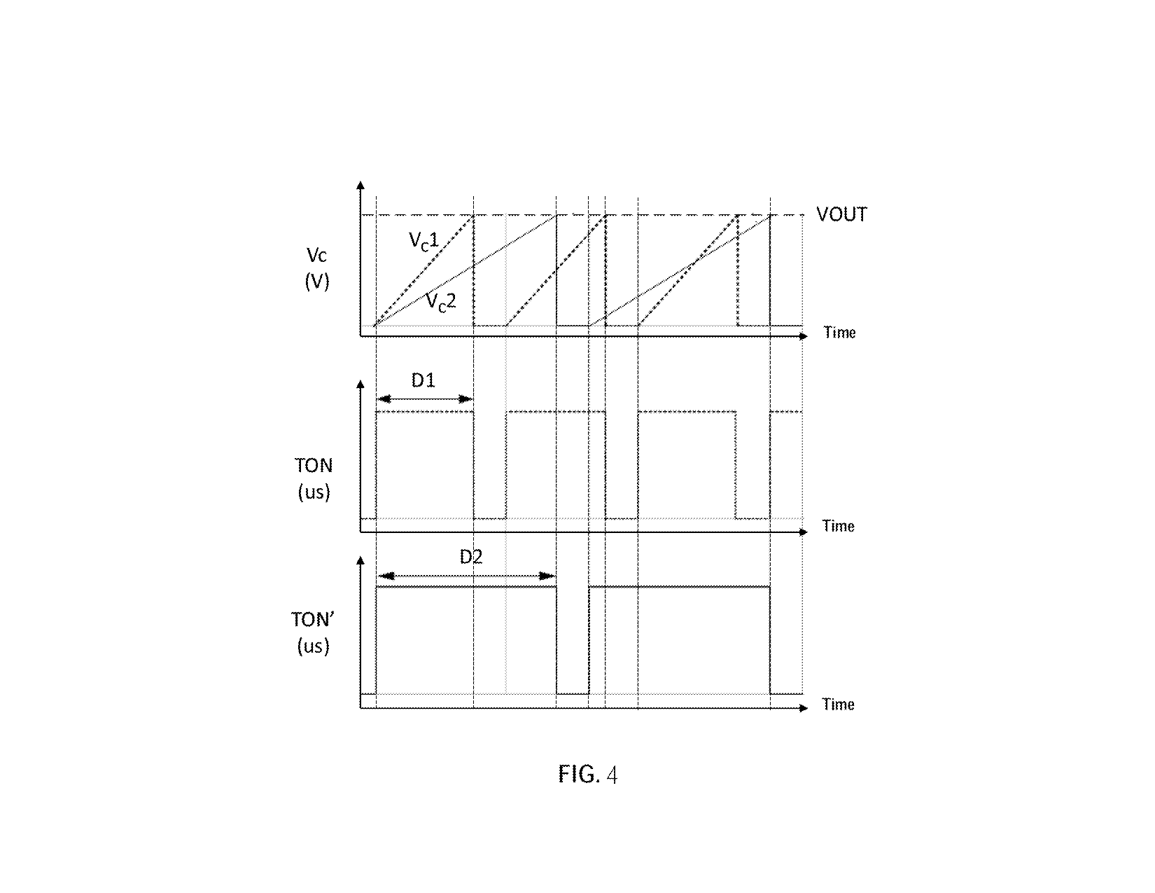

Please refer to FIG. 4. FIG. 4 is a waveform diagram of the charging voltage and the on-time. As shown in FIG. 4, if a charging voltage Vc at the node K is a first charging voltage Vc1, the first on-time TON is determined by a first time duration D1 required for the first charging voltage Vc1 to rise from zero to the output voltage VOUT. If the charging voltage Vc at the node K is a second charging voltage Vc2, the second on-time TON' is determined by a second time duration D2 required for a second charging voltage Vc2 to rise from zero to the output voltage VOUT. According to the embodiment of FIG. 4, when a second rising slope of the second charging voltage Vc2 is less than a first rising slope of the first charging voltage Vc1, the second on-time duration D2 of the second on-time TON' will be greater than the first on-time duration D1 of the first on-time TON, and vice versa.

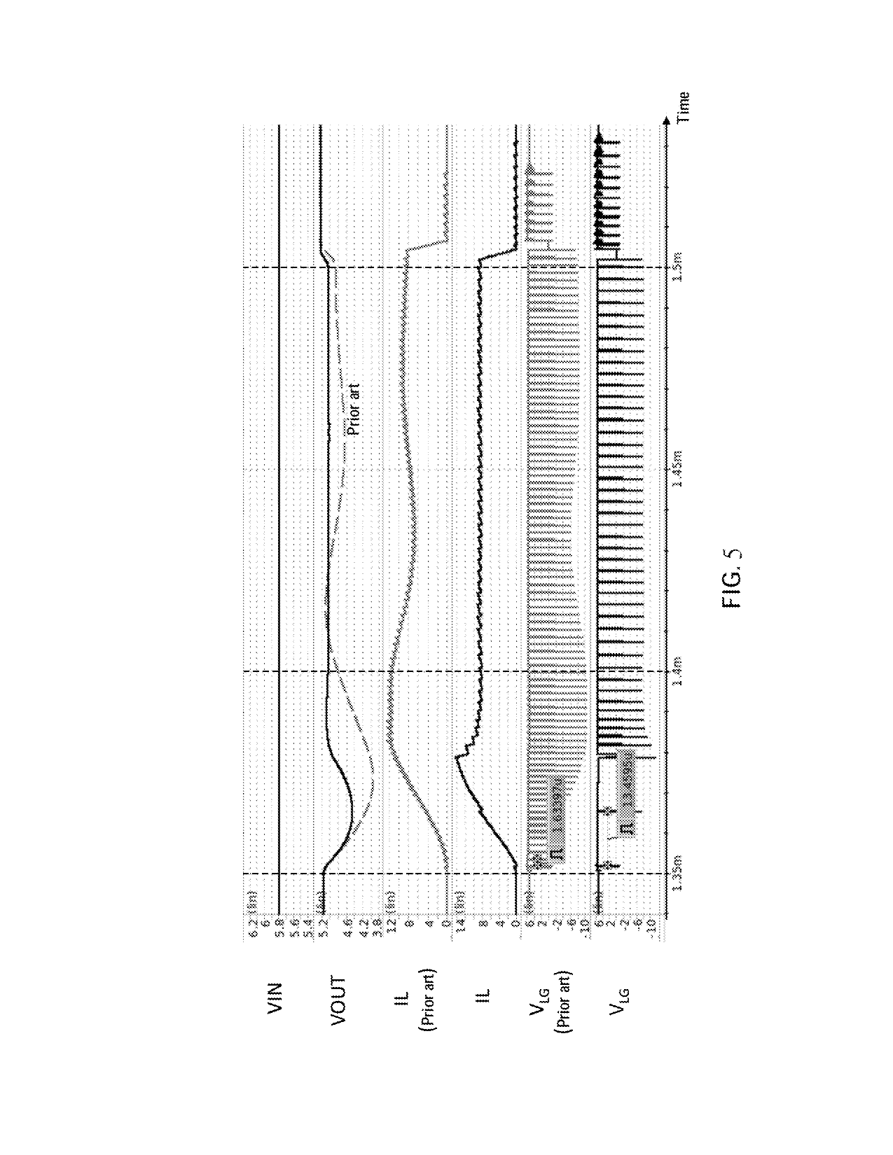

Please refer to FIG. 5. FIG. 5 is a waveform diagram of the input voltage VIN, the output voltage VOUT, the inductor current IL and the second switching signal VLG of the present invention and the prior art. It should be noted that the input voltage VIN of the present invention is the same as that of the prior art; the output voltage VOUT of the present invention is represented by a solid line, while the output voltage VOUT of the prior art is represented by a dotted line.

Comparing the output voltage VOUT and the inductor current IL of the prior art and the present invention, it can be seen that the prior art unloads the load at the time 1.35 ms, and the output voltage VOUT does not stabilize until the time 1.5 ms. However, the present invention unloads on the time 1.35 ms, and the output voltage VOUT is stabilized at the time 1.4 ms, which is still a long time before the unloading time 1.5 ms.

In summary, the controller of the power converter of the present invention can adjust the time required for the charging voltage in the on-time generation unit to rise to the output voltage by using an adjustment signal generated based on the cross-voltage between the two terminals of the compensation resistor, thereby further extending or shortening the on-time. Therefore, it can achieve the effect of transient modulation of the on-time, effectively reducing the overshoot and undershoot phenomenon of the output voltage of the conventional power converter, and providing faster and more stable transient response.

With the example and explanations above, the characteristics and spirits of the invention describe well. Those skilled in the art will readily observe that numerous modifications and alterations of the device may realize while retaining the teaching of the invention. Accordingly, the above disclosure construct as limited only by the metes and bounds of the appended claims.

What is claimed is:

1. A controller of a power converter, the controller providing a control signal to cause the power converter to generate an output voltage, the controller comprising:
an error amplifier, coupled to the power converter and configured to generate an error signal according to the output voltage;
a compensation circuit, coupled to the error amplifier and configured to generate a compensation signal according to the error signal, wherein the compensation circuit comprises a compensation resistor;
a comparison circuit, coupled to the compensation circuit and configured to generate a trigger signal according to the compensation signal;
an adjustment circuit, coupled to two terminals of the compensation resistor and configured to generate an adjustment signal according to a cross-voltage between the two terminals of the compensation resistor; and
a control signal generation circuit, coupled to the comparison circuit and the adjustment circuit and configured to generate a control signal according to the trigger signal and adjustment signal.

2. The controller of claim 1, wherein the compensation circuit further comprises a compensation capacitor, one terminal of the compensation capacitor is coupled to the compensation capacitor and the other terminal of the compensation capacitor is coupled to a ground terminal.

3. The controller of claim 1, wherein the adjustment circuit comprises a voltage-controlled current source configured to generate a current signal related the input voltage as the adjustment signal according to the cross-voltage between the two terminals of the compensation resistor.

4. The controller of claim 1, wherein the control signal generation circuit comprises:
an on-time generation unit, coupled to the adjustment circuit and configured to generate a first on-time or a second on-time according to the adjustment signal; and
a logic control unit, coupled to the on-time generation unit and configured to generate the control signal according to the first on-time or the second on-time.

5. The controller of claim 4, wherein the on-time generation unit comprises:
a current source, coupled to a node and configured to provide a current related to the input voltage;
a second capacitor, coupled between the node and a ground terminal;
a switch having two terminals being coupled to two terminals of the second capacitor respectively and configured to be turned on or off by a pulse width modulation signal; and
a comparator having a positive input terminal and a negative input terminal, the positive input terminal receiving the output voltage and the negative input terminal being coupled to the node;
wherein during the switch is turned off, the second capacitor being charged by a current, the comparator generating the first on-time or the second on-time based on the first charging voltage at the node and the output voltage.

6. The controller of claim 5, wherein the comparator determines the first on-time according to a first time length required for the first charging voltage to rise from zero to the output voltage, and determines the second on-time according to a second time length required for the second charging voltage to rise from zero to the output voltage.

7. The controller of claim 6, wherein the comparator generates the first on-time or the second on-time according to whether the adjustment signal generated by the adjustment circuit is a first current signal or a second current signal.

8. The controller of claim 7, wherein when a second rising slope of the second charging voltage is greater than a first rising slope of the first charging voltage, the second on-time is less than the first on-time.

9. The controller of claim 7, wherein when a second rising slope of the second charging voltage is less than a first rising slope of the first charging voltage, the second on-time is greater than the first on-time.

10. The controller of claim 5, wherein the current source is a current mirror circuit.
